(19) United States
(12) Patent Application Publication
(10) Pub. No.: US 2026/0265641 A1
(43) Pub. Date: Sep. 10, 2026

(54) CANDLE SYSTEM

(71) Applicant: Joya, LLC, Brooklyn, NY (US)

(72) Inventors: Frederick Bouchardy, Brooklyn, NY (US); José Luis Vargas, Brooklyn, NY (US)

(73) Assignee: Joya, LLC, Brooklyn, NY (US)

(21) Appl. No.: 19/557,473

(22) Filed: Mar. 5, 2026

Related U.S. Application Data
(60) Provisional application No. 63/767,109, filed on Mar. 5, 2025.

(51) Int. Cl. C11C 5/00; C11C 5/02

(52) U.S. Cl. CPC C11C 5/008; C11C 5/006; C11C 5/023

(57) ABSTRACT

A candle system including a shell including one or more walls defining a hollow, the shell being made of a first wax, an insert disposed in the hollow, the insert comprising a second wax having a lower melting point than the first wax, and a wick extending through the insert.

### CROSS-REFERENCE TO RELATED APPLICATIONS

This application claims priority under 35 U.S.C §120 from U.S. Provisional Application No. 63/767,109, filed on Mar. 5, 2025, in the United States Patent and Trademark Office, the disclosure of which is incorporated herein in its entirety by reference.

### BACKGROUND

Scented candles are in common use in households to put off desired smells. Scented candles are expendable, burning off a wax to generate the smell. When the wax has been burned, the candle must be replaced or refilled with fresh wax.

Scented wax has a different construction than the wax of unscented freestanding candles, making it less structurally resilient. When heated scented wax melts much more quickly than traditional candle wax. A freestanding candle made of scented wax would quickly lose its structure and melt into a puddle after being lit. As such, a scented candle customarily includes a vessel, such as a glass cup, which holds the scented wax and provides structure to the candle. When the scented wax in a candle is expended, the vessel may be refilled with new wax and used again.

Conventional refills for scented candles come in two forms. One is a bag of raw wax, either as powder or pellets which must be melted and then poured into the candle vessel. The second is a new candle with a new vessel, which avoids the effort and mess of having to melt and pour wax, as well as removing the need to clean out the vessel before refilling it.

Conventional refill methods have several problems. First, refills and new candles are customarily wrapped in plastic to protect them for shipping. This packaging generates plastic waste with each refill. Furthermore, when a scented candle is expended, customarily there is some unburned wax left in a vessel, which must be cleaned out before the vessel can be used again. The effort of manually cleaning the vessel leaves many users with no choice but to discard the vessel and buy a new candle. However, using new candles instead of refills also generates waste. In addition to the glass vessel itself being discarded with each new candle, these new candles must be shipped with substantial padding to keep from cracking the vessel during shipping. This padding becomes waste that is discarded by the end user. The amount of waste coming from replacing or refilling candles is not environmentally sustainable.

Still further, the plastic packaging around refills and new candles is not always watertight. As a result, refills and new candles must be stored at the right temperature during shipping, or they may melt and drip through the plastic packaging. As noted above, scented wax becomes liquid much quicker and at a lower temperature than regular candle wax, so if a candle refill is stored at too high of a temperature, it may melt and become unusable. This problem is especially pronounced when candle refills are shipped to areas like Arizona, with an ambient temperature in excess of one hundred degrees Fahrenheit.

There is therefore a need for a candle system that addresses at least some of the above concerns.

### SUMMARY OF THE INVENTION

Exemplary embodiments of the present general inventive concept may provide a candle system and methods of making the same.

The foregoing and/or other features and utilities of the present general inventive concept may be achieved by providing a candle system including a shell comprising one or more walls defining a hollow, the shell being made of a first wax, an insert disposed in the hollow, the insert comprising a second wax having a lower melting point than the first wax, and a wick extending through the insert.

In an exemplary embodiment, the shell may comprise beeswax.

In an exemplary embodiment, the shell may be configured to melt while the wick is lit.

In an exemplary embodiment, the shell may be configured to remain solid while the wick is lit.

In an exemplary embodiment, the second wax may be a scented wax comprising a scented oil blended with wax.

In an exemplary embodiment, the shell may further comprise a bottom wall at a first end of the hollow, the bottom wall having a higher thickness than any others of the one or more walls.

In an exemplary embodiment, the shell may further comprise a removable lid covering a second end of the hollow.

In an exemplary embodiment, the first wax may be biodegradable.

The foregoing and/or other features and utilities of the present general inventive concept may be achieved by providing a method of making a shell, the method including raising the temperature of a first wax to a first temperature, the first temperature being equal or greater than a melting point of the first wax and below a burning point of the first wax, pouring the first wax at the first temperature into a mold at a second temperature, emptying the mold of excess first wax after a predetermined time, and removing solidified first wax from the mold.

In an exemplary embodiment, the first temperature may be between about 106% and about 118% of a melting point of the first wax.

In an exemplary embodiment, the first temperature may be between about 89% and about 94.5% of a burning point of the first wax.

In an exemplary embodiment, the first wax may comprise beeswax.

In an exemplary embodiment, the first temperature may be in the range of about 160 to about 170 degrees Fahrenheit.

In an exemplary embodiment, the first temperature may be below 180 degrees Fahrenheit.

In an exemplary embodiment, the second temperature may be between about 46% and about 52% of the melting point of the first wax.

In an exemplary embodiment, the second temperature may be between about 70 degrees Fahrenheit and about 75 degrees Fahrenheit.

Additional features and utilities of the present general inventive concept will be set forth in part in the description which follows and, in part, will be obvious from the description, or may be learned by practice of the general inventive concept.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1A is an exploded view of a candle system according to an exemplary embodiment of the present general inventive concept;

FIG. 1B is a view of the candle system of FIG. 1A assembled according to an exemplary embodiment of the present general inventive concept;

FIG. 1C is a view of the candle system of FIG. 1A assembled with a lid removed according to an exemplary embodiment of the present general inventive concept;

FIG. 2 is a flowchart of a process to manufacture a shell of a candle system according to an exemplary embodiment of the present general inventive concept;

FIG. 3 illustrates wax being poured into a mold according to an exemplary embodiment of the present general inventive concept;

FIG. 4 illustrates a wax shell being cured in a mold according to an exemplary embodiment of the present general inventive concept;

FIG. 5 illustrates a shell being removed from a mold according to an exemplary embodiment of the present general inventive concept; and

FIG. 6 illustrates a shell after being removed from the mold according to an exemplary embodiment of the present general inventive concept.

### DETAILED DESCRIPTION OF EXEMPLARY EMBODIMENTS OF THE INVENTIVE CONCEPT

Reference will now be made in detail to embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, certain terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part "includes" or "comprises" an element, unless there is a particular description contrary thereto, the part can further include other elements, not excluding the other elements.

Hereinafter, one or more exemplary embodiments of the present general inventive concept will be described in detail with reference to accompanying drawings.

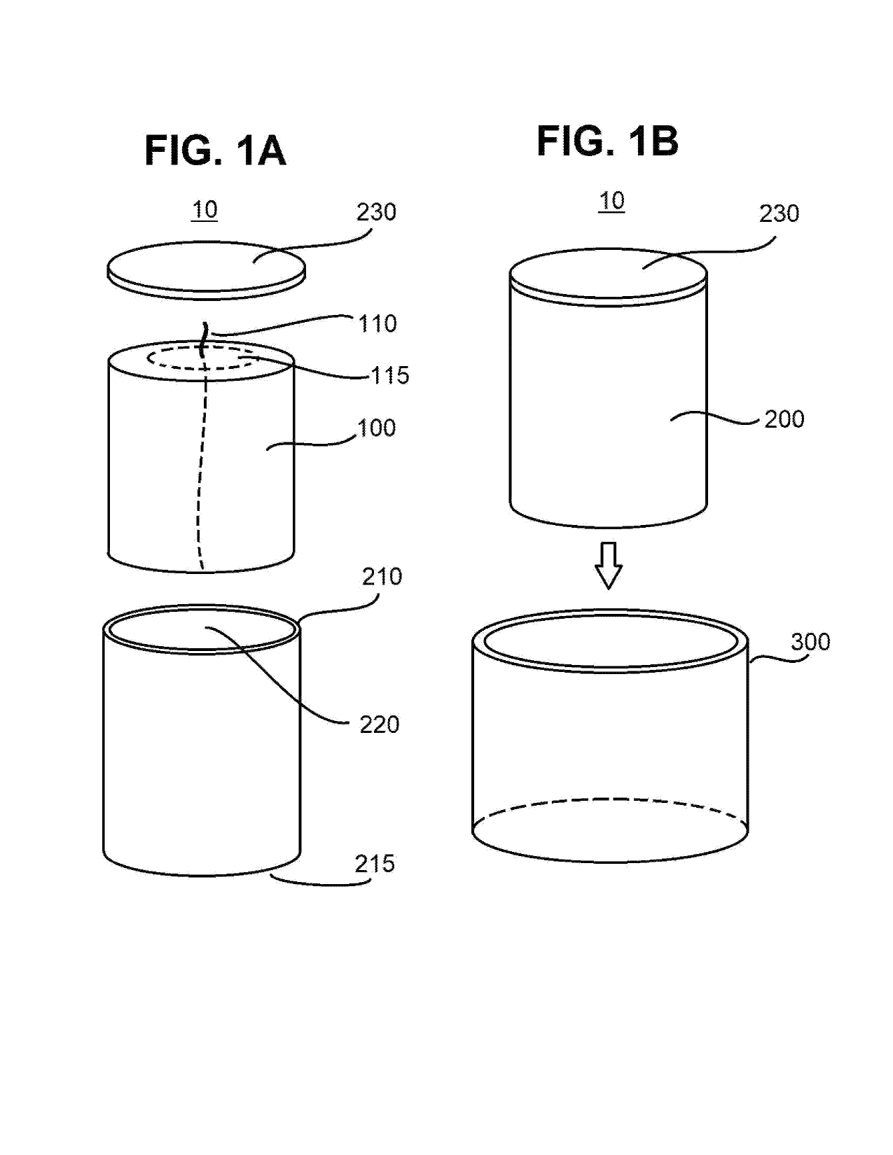

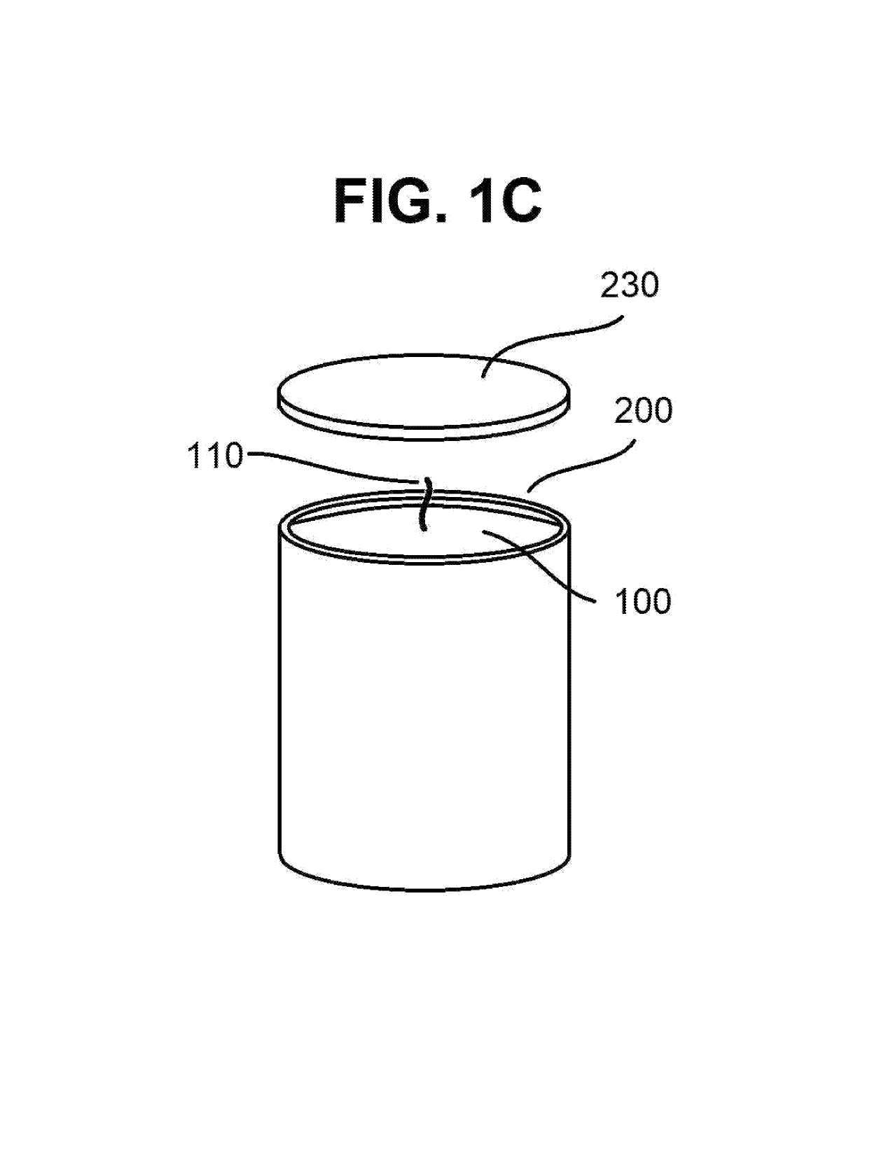

FIG. 1A illustrates an exploded view of candle system 10 according to an exemplary embodiment of the present general inventive concept. FIG. 1B is a view of the candle system 10 of FIG. 1A, assembled according to an exemplary embodiment of the present general inventive concept. As illustrated therein, the system 10 may include an insert 100 contained within a shell 200.

The insert 100 may be made of a scented wax having any desired scent or construction. According to an exemplary embodiment of the present general inventive concept, the insert 100 may comprise a wax such as a coconut wax or a soy wax, which may be blended with a scented oil, which may provide a desired scent when the wax is burned. The insert 100 may also include a wick 110 which a user may light to generate a flame that melts and vaporizes the insert 100, which in turn may disperse the desired scent into the air. As illustrated in FIG. 1, the wick 110 may extend through the insert 100 and protrude out one end. The wick 110 may also be positioned in the center of the insert 100, such that heat from the wick 110 when it is lit is distributed evenly across the insert 100.

The shell 200 may be made of a biodegradable or compostable material with a melting point higher than that of the insert 100, but also strong enough to serve as packaging material for the insert 100. According to exemplary embodiments of the present general inventive concept the shell 200 may be strong enough to support a plurality of candle systems 10 stacked on top of each other, and resilient enough to withstand impacts during shipping without cracking or breaking. According to an exemplary embodiment of the present general inventive concept, the shell 200 may be made of beeswax or a similar biodegradable or compostable material. Beeswax in particular is highly malleable and may resist moderate temperature variations well, and so can accommodate different inserts 100 without compromising performance of the candle system 10. According to other exemplary embodiments of the present general inventive concept, the shell 200 may be made of, e.g., sunflower wax, rice wax, or any other kind of biodegradable hard wax. The specific material for the shell 200 may be selected based on the desired purpose and end destination of the candle system 10. Wax used for the shell 200 may be selected based on its melting point, burn rate, and overall stability.

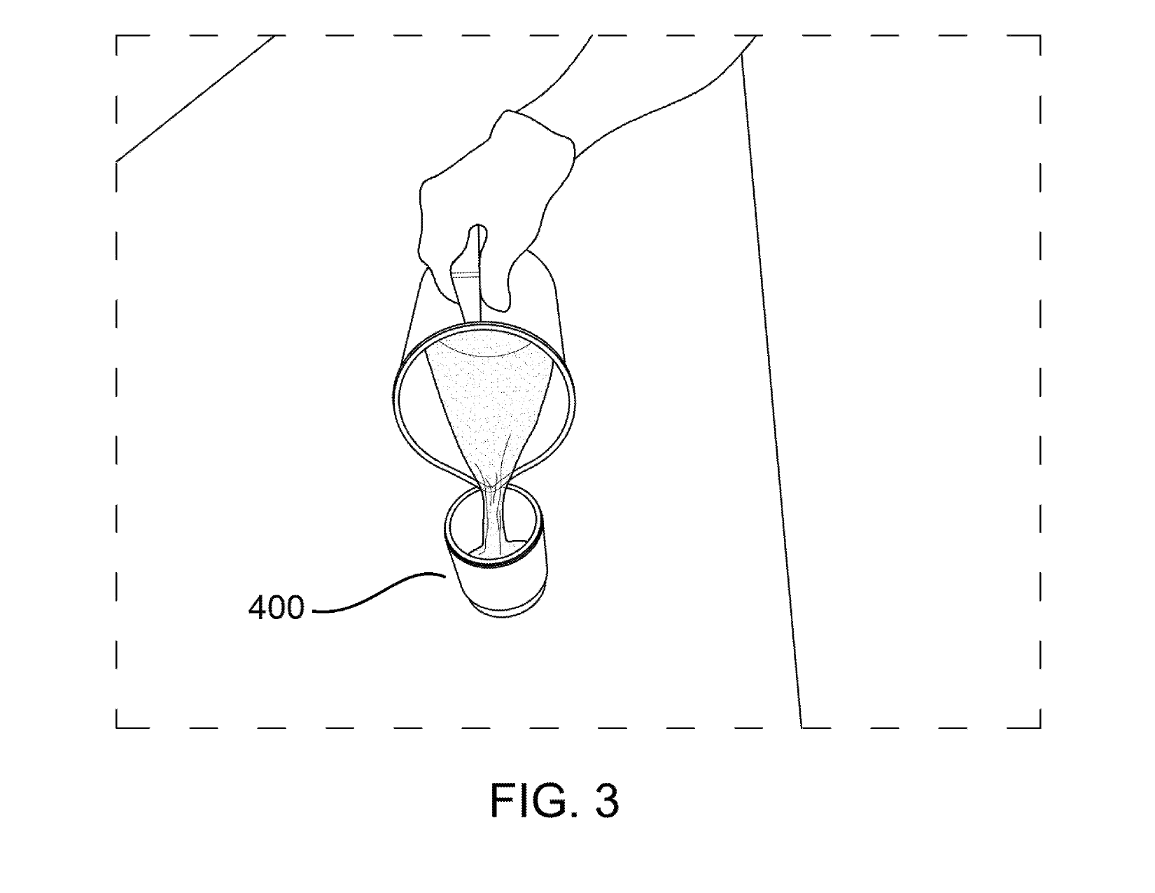

According to exemplary embodiments of the present general inventive concept, the shell 200 may be slipcast, i.e., the raw material may be melted into a liquid which is then poured into a prepared mold 400 (illustrated in FIGS. 3-6), and subsequently poured out of the mold 400 after a set time. This process leaves a hollow form in the shape of the mold 400, which can then be removed from the mold 400 to produce the shell 200.

Once formed, the shell 200 may include one or more walls 210 defining a hollow 220. The hollow 220 may be closed by a bottom wall 215 on one end and open on another end of the shell 200. The hollow 220 may contain the insert 100, such that the wall(s) 210 and the bottom wall 215 of the shell 200 may give the insert 100 structure so that the insert 100 remains in the candle system 10 while the wick 110 is burning. According to exemplary embodiments of the present general inventive concept, the candle system 10 may be free-standing and require no external support to keep its shape while the wick 110 is burning. According to other exemplary embodiments of the present general inventive concept, the shell 200 may be inserted into a decorative candle vessel 300 such as a cup, bowl, or other device (illustrated in FIG. 1B, with a dashed line for the back wall to indicate the vessel 300 may be transparent). The vessel 300 may be made of any fire-resistant material, for example glass or porcelain. The vessel 300 may provide extra safety to contain any potential drips, and may also enhance the aesthetic appearance of the candle system 10, for example allowing the user to use a vessel 300 with a desired pattern or visual appearance.

The insert 100 may be made of a relatively softer material than the shell 200, for example because the insert 100 includes scented oil blended with the wax. The shell 200 may be made without this scented oil, and as a result may be structurally stronger and retain its shape better than the insert 100, especially when the wick 110 is burning and applying heat to the candle system 10.

When lit, the wick 110 may generate a flame which melts the wax around it. This liquid wax may be drawn up the wick 110 by capillary action, and fuel the flame. The wick 110 may burn at a predetermined temperature when it is lit. This temperature may depend upon multiple factors, for example a diameter of the wick 110 and a composition of the insert 100. For example, according to different exemplary embodiments of the present general inventive concept the insert 100 may be composed of a wax that burns at a relatively high or a relatively low temperature. Furthermore, a wick 110 with a wider diameter may burn hotter than a wick 110 with a smaller diameter, since a wider wick 110 may draw up more melted wax at once to be burned. The temperature at which a wick 110 burns may be measured according to the “melt pool” 115, or pool of melted wax that forms around the wick 110 while it is burning. A wider melt pool 115 may indicate a wick 110 burning at a relatively higher temperature, and a smaller melt pool 115 may indicate a wick 110 burning at a relatively lower temperature. For the purposes of this application, the size of the melt pool 115 may be measured by how wide a pool forms over a preset amount of time, for example 4 hours of burning the wick 110 under controlled conditions, i.e., a steady ambient temperature. A sample melt pool 115 is illustrated in FIG. 1A. It will be understood that the relative size of the melt pool 115 may vary depending on the particular exemplary embodiment of the present general inventive concept, as will be described in greater detail below.

The temperature of the wick 110 may affect a burn period, i.e., how long the candle system 10 may burn before it is expended. In general, the hotter a wick 110 burns, the faster the candle system 100 is expended, since higher heat means wax is being burned more quickly and a melt pool 115 is being formed more rapidly. As such, a user may control how long the system 10 may burn by controlling a size of the wick 110. In addition to burning hotter and faster, a larger wick 110 may furthermore allow for more flexibility in the type of wax in the insert 100. Relatively narrow wicks 110 risk becoming blocked, for example with resin included in the scented wax of insert 100. Such a blockage may prevent wax from flowing up the wick 110, causing the candle system 10 to burn out prematurely. So a smaller wick 110 may be used with an insert 100 that lacks resin or other such materials. In comparison, a larger wick 110 may have more room to allow substances such as resin to pass up the wick 110 without creating a blockage, and so can be used with inserts 100 that include such materials.

According to exemplary embodiments of the present general inventive concept, the wick 110 may burn at a temperature below the melting point of shell 200, so that shell 200 may remain solid and retain its shape while the insert 100 melts. Such a wick 110 may have a melt pool 115 smaller than a maximum diameter of the insert 100. According to this exemplary embodiment of the present general inventive concept, heat from the burning wick 110 may vaporize the insert 100 to make the desired scent without destroying the shell 200.

According to this exemplary embodiment, once the insert 100 is burned out or fully vaporized, the shell 200 may be discarded. The user may then use a new candle system 10, inserting it into the candle vessel 300 as desired. The shell 200 may effectively contain the insert 100 to prevent drips, and so the vessel 300 may remain clear of wax while the insert 100 burns. As such, the shell 200 can be cleanly removed and the candle system 10 can be replaced without needing to clean or discard the vessel 300. Furthermore, if the shell 200 is made of a biodegradable or compostable material such as, for example, beeswax, the shell 200 may make no substantial waste, since it may naturally decompose in a landfill.

According to other exemplary embodiments of the present general inventive concept, the wick 110 may burn at a temperature equal to or greater than a melting point of the shell 200. Such a wick 110 may have a melt pool 115 equal to or greater in size than a maximum diameter of the insert 100. According to this exemplary embodiment, the shell 200 may be consumed with the insert 100, i.e., the shell 200 may melt and be vaporized along with the scented wax of the insert 100. According to such exemplary embodiments of the present general inventive concept, the wick 110 may be relatively thicker than a wick 110 in a system 10 where the shell 200 does not melt. In such an embodiment where the shell 200 is configured to melt, the shell 200 may melt more slowly than the insert 100, since it may have a higher melting point that the insert 100 and may be further from the wick 110 than the insert 100. The wick 110 may be placed in the center of the candle system 10, ensuring that the wax of the insert 100 and shell 200 are burned evenly. As the wick 110 burns, the insert 100 may melt first, followed by the shell 200 as the melt pool 115 grows large enough to reach the shell 200, such that the shell 200 melts and may be drawn up the wick 110 to be vaporized along with the insert 100. The shell 200 may melt at a slower rate than the insert 100, since the shell 200 is furthest part of the system 10 from the wick 110, and heat from the wick 110 must transfer through the insert 100 to the shell 200 as the melt pool 115 forms. As such, the shell 200 may melt and vaporize more slowly than the insert 100, and so a height of the insert 100 or the melt pool 115 may never be higher than an edge of the shell 200. As such the melt pool 115 may be contained by the shell 200, and the shell 200 may still contain the insert 100 and prevent drips even as the shell 200 itself melts.

In both exemplary embodiments described above, i.e., an exemplary embodiment where the shell 200 remains solid while the wick 110 is burning and an exemplary embodiment where the shell 200 vaporizes while the wick 110 is burning, the wick 110 may extend through the insert 100 but not into the shell 200, as illustrated for example in FIG. 1A. As such, when the insert 100 is expended, the wick 110 may also be expended, such that it is unable to draw up more liquid wax and burns out. This may leave a portion of the shell 200 still solid after the insert 100 has been expended. As a result, even if the shell 200 is configured to be melted and vaporized along with the insert 100, a portion of the shell 200, for example a bottom wall 215 of the shell 200, may still remain un-vaporized when the wick 110 is used up. As described above, the shell 200 may melt more slowly than the insert 100, and so may contain the melt pool 115 while the wick 110 is burning. As a result, the candle system 10 may not drip in or otherwise contaminate a vessel 300 or surface it is sitting on. To the contrary, the remainder of the shell 200 may be cleanly removed and discarded. As noted above, if the shell 200 is biodegradable or compostable it will result in negligible waste. In exemplary embodiments where the shell 200 is vaporized, bottom wall 215 of the shell 200 may be made thicker than the walls 210 of the shell, to help maintain the structure of the bottom wall 215 intact while the shell 200 melts. A thicker bottom wall 215, for example about 100% thicker than the wall(s) 210, may improve structural strength and load resistance for the shell 200 as a whole.

According to exemplary embodiments of the present general inventive concept, the shell 200 may serve as both packaging and support for the insert 100. More specifically, the material of the shell 200 may be strong enough that the hollow 220 is a watertight enclosure, which may support the insert 100 while the wick 110 is burning, preventing the insert 100 from dripping over an outer surface of the system 10. According to exemplary embodiments of the present general inventive concept, an upper edge of the insert 100 may be spaced a predetermined distance from an upper edge of the shell 200, as illustrated in FIG. 1C, which may help prevent the melt pool 115 from spilling over an edge of the shell 200.

As described above according to exemplary embodiments of the present general inventive concept the shell 200 may also be strong enough to support the insert 100 during shipping, for example supporting the weight of the system 10 and a given number of systems 10 stacked on top of it, without cracking even under a sharp impact, for example if the system 10 is jostled or dropped during shipping. When shipped, multiple layers of the system 10 stacked on top of each other may be separated, for example with padding or sheets of cardboard, to control load distribution such that lower layers of the system 10 are not damaged by weight of the upper layers. According to exemplary embodiments of the present general inventive concept, an empty shell 200, i.e., without the insert 100, may be stacked without padding. That is, the material of the shell 200 may be resilient enough to serve as packaging and support multiple shells 200 stacked on one another.

According to exemplary embodiments of the present general inventive concept, a melting point of the shell 200 may be greater than the ambient temperature of a shipping destination. Since wax may become plastic and flexible even before it melts, the shell 200 may have a melting point greater than 100 degrees Fahrenheit, so that the shell 200 may maintain its shape even when shipped to a hot climate such as, for example, Arizona. As such, even if the ambient temperature is high enough to melt the insert 100, the shell 200 may still contain the insert 100 in the watertight enclosure of the hollow 220. According to exemplary embodiments of the present general inventive concept, beeswax may provide the required qualities of hardness, strength, and melting point for the shell 200. That is, beeswax may have a melting point substantially higher than a temperature of the insert 100, and also have the desired strength properties to serve as packaging, meaning that it may maintain structural stability under normal storage and usage conditions and temperatures. Other materials can be used for the shell 200 according to different exemplary embodiments of the present general inventive concept, depending on the intended use or destination. For example, the shell 200 may be made of a material with a relatively higher melting point if the candle system 10 is intended to be used in a location with a high ambient temperature.

The wall(s) 210 of the shell 200 may be kept within a predetermined range of thickness, such that they can support the insert 100 during shipping and use while also leaving enough room for the insert 100 in the hollow 220. According to exemplary embodiments of the present general inventive concept, the walls 210 of the shell 200 may be between 1/8 of an inch to 3/16 of an inch thick.

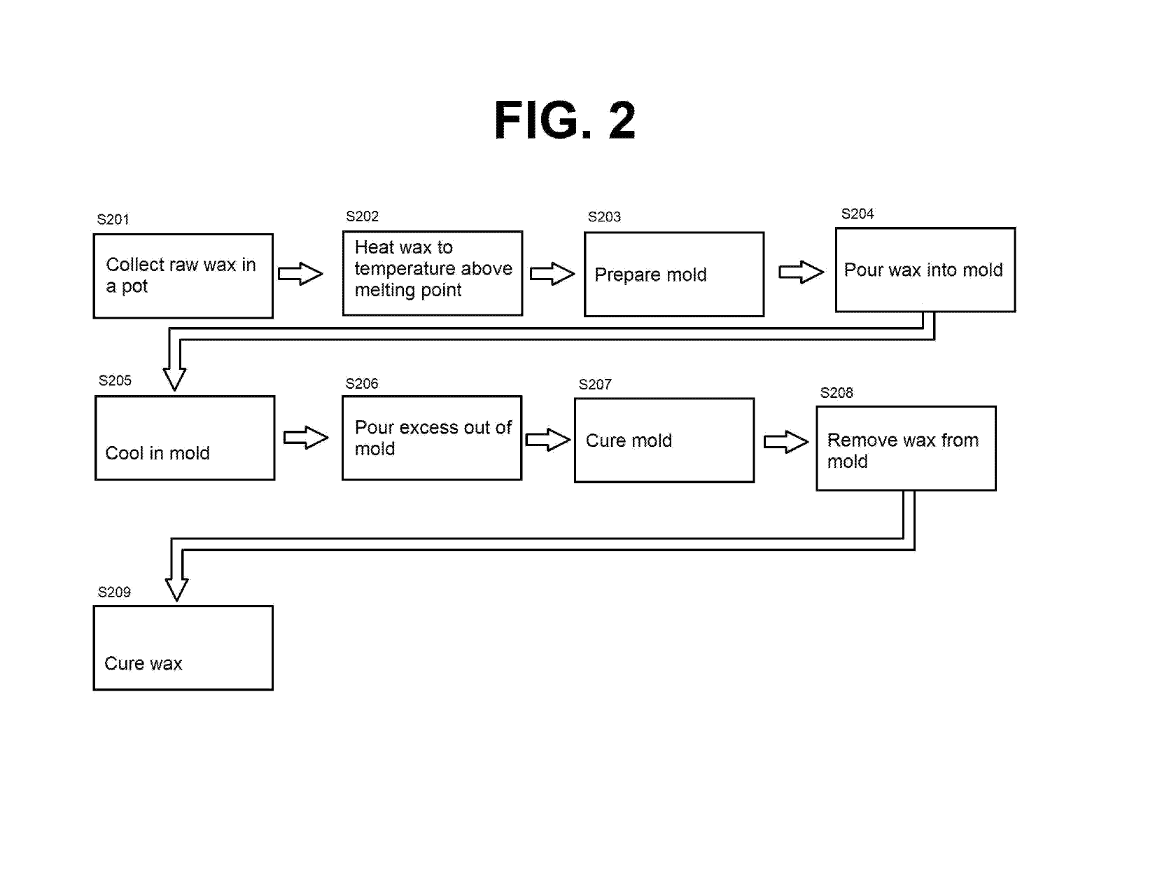

FIG. 2 is a flowchart illustrating a process of manufacturing a shell 200 according to an exemplary embodiment of the present general inventive concept. Beeswax is referred to as the shell material in the description, but it will be understood that any other suitable material may be used without departing from the present general inventive concept.

As illustrated in FIG. 2, at Step S201 raw wax may be collected in a pot or other container. The raw wax may be in a solid or liquid state.

At Step S202, the raw wax may be heated to a temperature equal to or greater than its melting point, but below a burning point. According to exemplary embodiments of the present general inventive concept, the wax may be heated to between about 106% and 118% of the melting point. If the wax is heated to too low a temperature, even if melted, the liquid wax may solidify too quickly when cooled in Steps S204-S207, described in detail below. Solidifying too quickly may result in bubbles in the solidified wax, drip lines, and uneven thickness in the wall(s) 210. These may lead to an undesirable appearance and performance for the shell 200. For example, bubbles in the wax may structurally compromise the shell 200 so that it breaks during shipping or during use, causing overflow of the insert 100. Similarly, uneven thickness in the wall(s) 210 of the shell 200 may lead to undesirable performance, for example the shell 200 being inconsistently heated while the wick 110 is burning such that the shell 200 melts prematurely in one spot, causing drips or overflow from the insert 100.

Conversely, if the wax for the shell 200 is heated to too high of a temperature, the wax may burn. When wax “burns,” its physical properties, including texture, melting performance, and scent, may irreversibly change. For example, burned beeswax may become discolored, and may produce soot or a “burning plastic” smell when melted, which may overcome the smell of a scented wax insert 100. According to exemplary embodiments of the present general inventive concept, the raw wax may be heated to between about 89% and about 94.5% of a burning point. This may help ensure the shell 200 is formed with consistent walls 210, minimal structural defects, and desired performance. For example, beeswax may have a melting point between 144 to 150 degrees Fahrenheit, and a burning point of about 180 degrees Fahrenheit. According to exemplary embodiments of the present general inventive concept, at Step S202 beeswax may be heated to between about 160 degrees Fahrenheit and about 170 degrees Fahrenheit. For the purposes of this application, “about” may include temperatures within three degrees Fahrenheit of the target temperature.

Once wax is melted at step S202 and heated to a uniform temperature, at Step S203 a mold 400 may be prepared. According to exemplary embodiments of the present general inventive concept, the mold 400 may be, e.g., a ceramic cup or other vessel that is able to hold the molten wax and has the desired shape for the shell 200. The mold 400 may additionally be sprayed with a mold release, i.e., a lubricant, to help with removing wax from the mold 400 in step S208, described below. The mold 400 may be brought to a temperature between about 46% and about 52% of a melting point of the wax, which may ensure a stable, predictable formation of the shell 200, in which the wax levels itself and cures smoothly, replicating a texture of the mold surface. Within this range of temperatures the molten wax may adhere sufficiently to the mold 400 to form the shell 200, and the shell 200 may form with uniform wall thickness and minimal internal stress. According to an exemplary embodiment of the present general inventive concept, if beeswax is used for the shell 200, the mold may be brought to between about 70 and about 75 degrees Fahrenheit. If the mold 400 is too hot, i.e., significantly above 52% of the wax’s melting point, the thermal differential between the wax and the mold 400 can affect curing behavior of the wax, surface finish, and dimensional consistency during casting, i.e., during Steps S204-S207, described below. If instead the mold 400 is too cold, i.e., significantly below 46% of the wax’s melting point, the thermal differential between the wax and the mold 400 may cause rapid surface cooling of the wax during casting, such that the wax solidifies almost as soon as it contacts the mold 400. Such rapid surface cooling can cause sink marks or adhesion issues. Rapid solidification may also interrupt a natural flow leveling of the liquid wax and create surface irregularities in the shell 200. These irregularities may include, for example, wave patterns or organic textures. Because the cooling rate may vary slightly each time wax is poured into the mold 400, the resulting shell 200 may be unique every time it is made, if the temperature of the mold 400 is below 46% of the wax’s melting point.

At Step S204, liquid wax may be poured into the mold 400, filling the mold 400 up to a desired level. By adjusting the level the mold 400 is filled to, a user may adjust the final height of the shell 200. An example of wax being poured into a mold 400 is illustrated in FIG. 3.

At Step S205, the liquid wax is allowed to cool in the mold 400 for a predetermined length of time. The length of time may be adjusted depending on the desired wall thickness of the shell 200. The longer the wax is allowed to cure, the thicker the walls 210 of the resulting shell 200 will be. As noted above, the thickness of wall(s) 210 must be thick enough that the shell 200 may serve as packaging, but not so thick that they excessively limit the size of the insert 100. According to exemplary embodiments of the present general inventive concept, the liquid wax may be allowed to cure in the mold 400 for between about 10 seconds and about one minute. According to other exemplary embodiments of the present general inventive concept, the liquid wax may be allowed to cure in the mold 400 for between about 15 and about 20 seconds. For the purposes of this application, “about” may mean within three seconds of the target number.

At Step S206, excess wax may be poured out of the mold 400. In this step, the excess wax may be poured back into the original pot holding the liquid wax. Following this process, the walls of the mold 400 should be coated with wax which has solidified to a desired thickness. This solidified coating may correspond to the wall(s) 210 and bottom wall 215 of the shell 200. According to exemplary embodiments of the present general inventive concept, during Step S206 a predetermined amount of liquid wax may be left in the mold 400. Gravity may cause this liquid wax to pool on the bottom of the mold 400, which may harden and create additional material buildup on the bottom wall 215, which may make the bottom wall 215 thicker than the other wall(s) 210 by a predetermined amount.

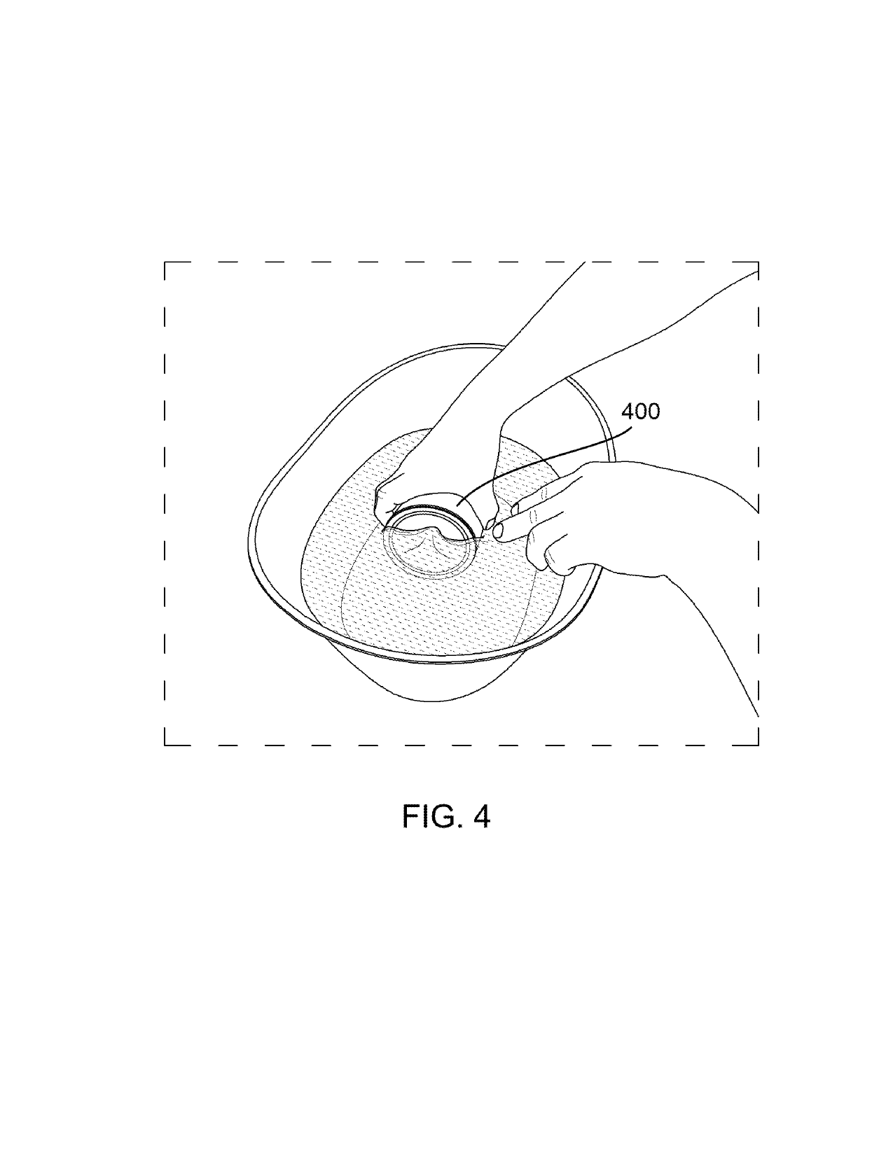

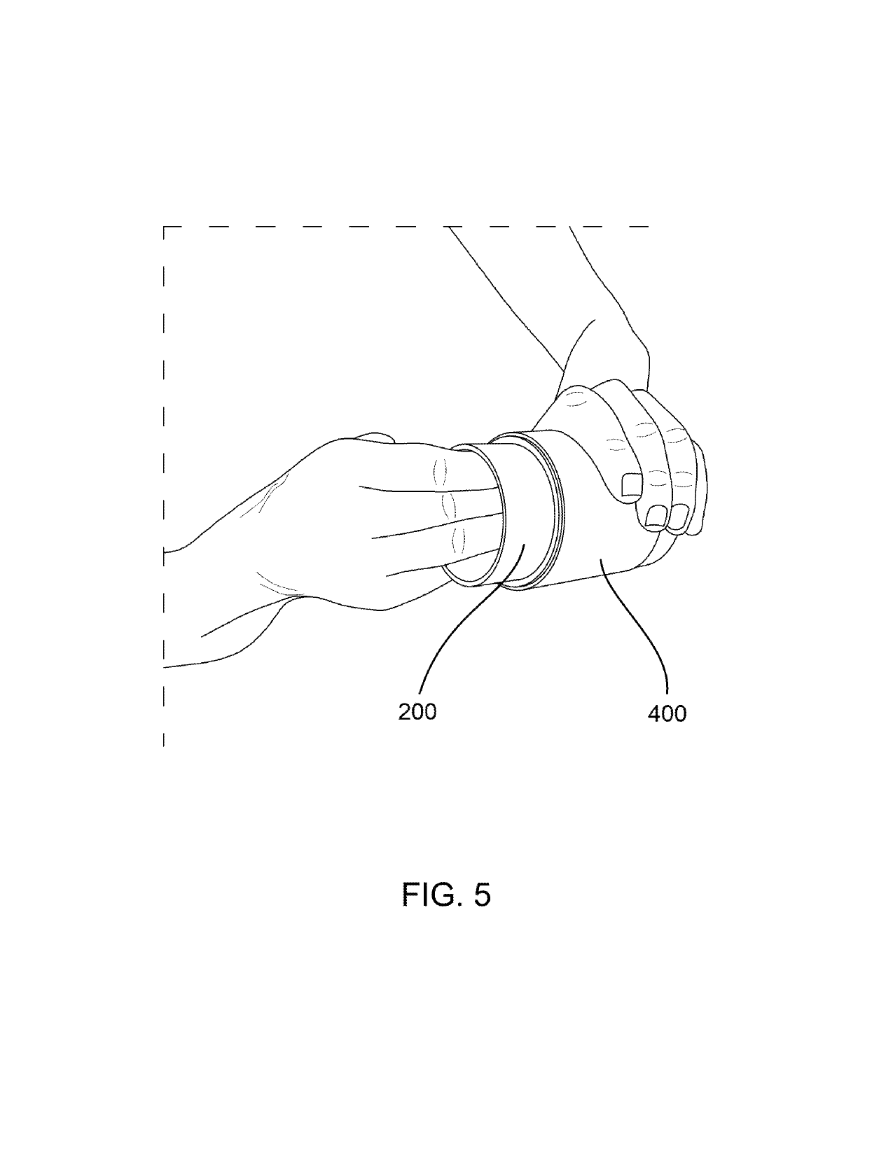

At Step S207, the mold 400, including the wax coating, may be cured. This step may comprise rapidly lowering the mold 400 and the solidified wax inside to a desired temperature, so that the wax fully hardens. According to exemplary embodiments of the present general inventive concept, the mold 400 and hardened wax may be cured by immersing the mold 400 in water at a temperature lower than a temperature of the mold, for example between about 65 degrees Fahrenheit and about 70 degrees Fahrenheit. FIG. 4 illustrates a mold 400 that has had the excess wax poured out, leaving a layer of hardened wax on the inner walls, and which is being immersed in water.

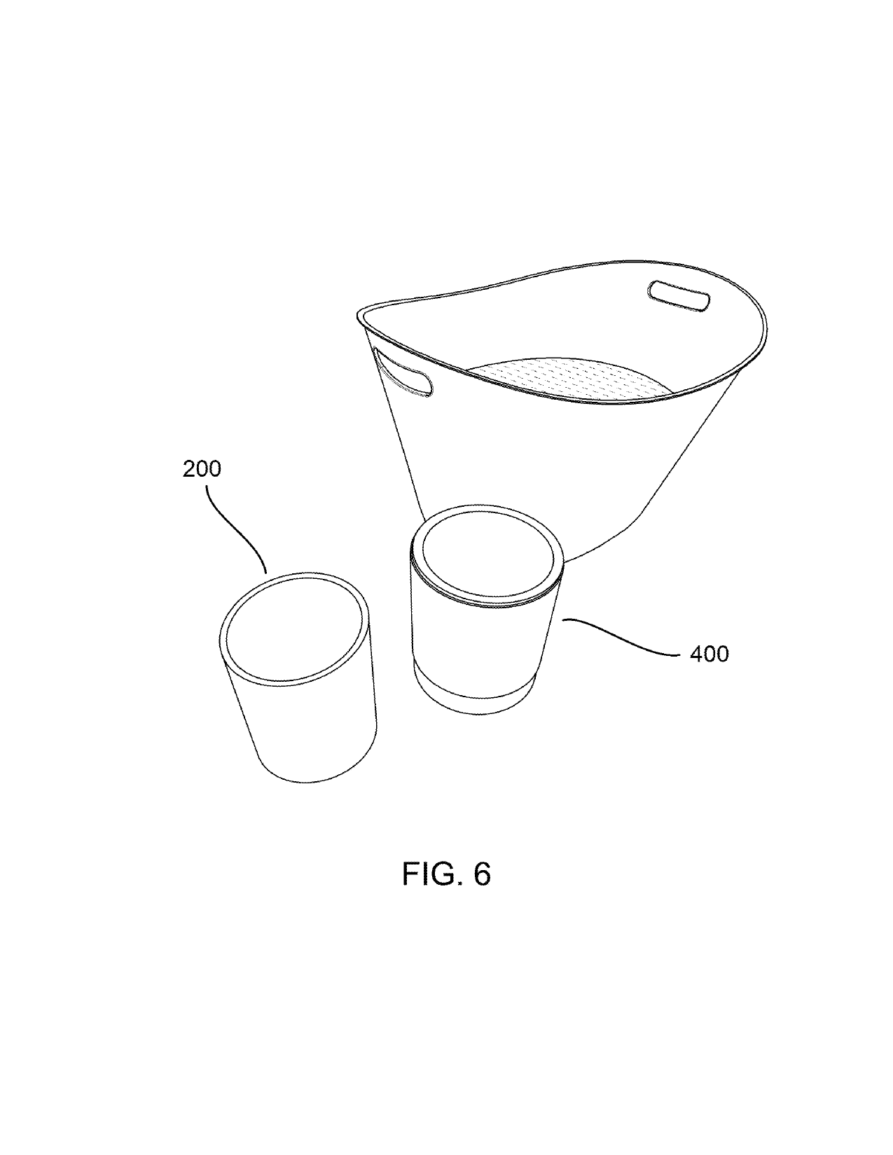

At Step S208, the cured wax inside of the mold 400 may be removed. Beeswax naturally shrinks away from a mold when it hardens, so hardened beeswax may be relatively easy to remove from the mold 400 without damaging either the wax or the mold 400. FIG. 5 illustrates a wax shell 200 being removed from the mold 400 according to an exemplary embodiment of the present general inventive concept.

The mold 400 may be made of any material suitable to the desired end use of the candle system 10. If the candle system 10 is intended to be used in a vessel 300 as a refill, then the mold 400 may be made of a rigid material such as, e.g., ceramic, porcelain, or glass. Such a rigid mold material may help maintain dimensional stability in the shell 200 during casting, such that shell 200 may precisely match the internal shape of the vessel 300 without gaps, distortion, or shrinkage. A shell 200 cast in such a mold 400 can smoothly fit into an intended vessel 300.

If the candle system 10 is instead intended to be used as a stand-alone candle, i.e., to be used without a separate vessel 300, then the mold 400 may instead be made of a more flexible material such as, for example, silicone. A flexible mold material may make removing the shell 200 from the mold 400 easier, since the mold 400 can be stretched or squeezed to remove the shell 200 during step S208. A flexible mold 400 may furthermore allow decorative exterior details, e.g., patterns or sculptures, to be formed in the wall(s) 210 of the shell 200 during casting, since the flexible mold 400 may be peeled off of the shell 200 during step S208.

Regardless of the intended use of the candle system 10, the mold material may be one that remains stable, without deforming, at an ambient temperature between about 65 degrees Fahrenheit and about 75 degrees Fahrenheit.

At Step S209, the removed hardened wax may be cured again, for example by allowing it to sit at a predetermined ambient temperature for a predetermined time, for example sitting at about 70 degrees Fahrenheit for about an hour. FIG. 6 illustrates a shell 200 that has been removed from the mold 400 according to an exemplary embodiment of the present general inventive concept. According to exemplary embodiments of the present general inventive concept, during Step S209 a predetermined amount of liquid wax at a predetermined temperature may be poured into the shell 200. This liquid wax may bond to the existing bottom wall 215 of the shell, forming an integrated thicker bottom wall 215 as it solidifies during curing. This exemplary embodiment may allow a user to more precisely control a final thickness of bottom wall 215, as compared to leaving additional liquid wax in the mold 400 during Step S206 described above. The temperature of this additional liquid wax is preferably within the same temperature range as the liquid wax in Step S202. This temperature range may allow the additional liquid wax to bond to the bottom wall 215 without deforming the wall(s) 210 with excess heat.

Following Step S209, the shell 200 may be considered complete. The shell 200 may then be filled with an insert 100 and be packaged for shipping. According to exemplary embodiments of the present general inventive concept, the insert 100 may be solid with the wick 110 in place in the center, such that the insert 100 may be inserted into the completed shell 200. According to other exemplary embodiments of the present general inventive concept, if the melting point of the shell 200 is substantially higher than a melting point of the insert 100, then the insert may be poured into the shell 200 in a melted liquid state, a wick 110 may be positioned in the liquid wax, and the wax may be allowed to harden to form the insert 100.

According to an exemplary embodiment of the present general inventive concept, the shell 200 may also include a removable lid 230 made of the same material as the rest of the shell 200. This lid may be made by a similar process as the shell 200, i.e., it may be made by pouring liquid wax into a mold and allowing it to form a desired thickness before excess is removed and the solid wax is cured. This lid 230 may be affixed over an open end of the hollow 220 to help contain the insert 100 during shipping, and may be removed and discarded before the candle system 10 is put to use. If the lid 230 is made of the same biodegradable or compostable material as the rest of the shell 200, then it should not contribute substantially to waste.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A candle system, comprising:
a shell comprising one or more walls defining a hollow, the shell being made of a first wax;
an insert disposed in the hollow, the insert comprising a second wax having a lower melting point than the first wax; and
a wick extending through the insert.

2. The candle system of claim 1, wherein the shell comprises beeswax.

3. The candle system of claim 1, wherein the shell is configured to melt while the wick is lit.

4. The candle system of claim 1, wherein the shell is configured to remain solid while the wick is lit.

5. The candle system of claim 1, wherein the second wax is a scented wax comprising a scented oil blended with wax.

6. The candle system of claim 1, wherein the shell further comprises a bottom wall at a first end of the hollow, the bottom wall having a higher thickness than any others of the one or more walls.

7. The candle system of claim 6, wherein the shell further comprises a removable lid covering a second end of the hollow.

8. The candle system of claim 1, wherein the first wax is biodegradable.

9. A method of making a shell, the method comprising:
raising the temperature of a first wax to a first temperature, the first temperature being equal to or greater than a melting point of the first wax and below a burning point of the first wax;
pouring the first wax at the first temperature into a mold at a second temperature;
emptying the mold of excess first wax after a predetermined time; and
removing solidified first wax from the mold.

10. The method of claim 9, wherein the first temperature is between about 106% and about 118% of a melting point of the first wax.

11. The method of claim 10, wherein the first temperature is between about 89% and about 94.5% of a burning point of the first wax.

12. The method of claim 9, wherein the first wax comprises beeswax.

13. The method of claim 9, wherein the first temperature is in the range of about 160 to about 170 degrees Fahrenheit.

14. The method of claim 9, wherein the first temperature is below 180 degrees Fahrenheit.

15. The method of claim 9, wherein the second temperature is between about 46% and about 52% of the melting point of the first wax.

16. The method of claim 15, wherein the second temperature is between about 70 degrees Fahrenheit and about 75 degrees Fahrenheit.
